(19) United States
(12) Patent Application Publication
(10) Pub. No.: US 2019/0166867 A1
(43) Pub. Date: Jun. 6, 2019

(54) OIL OR FAT COMPOSITION FOR FRIED FOODS, METHOD FOR PRODUCING OIL OR FAT COMPOSITION FOR FRIED FOODS, METHOD FOR PRODUCING FRIED FOODS, AND METHOD FOR IMPARTING CHEESE FLAVOR TO FRIED FOODS

(71) Applicant: J-OIL MILLS, Inc., Tokyo (JP)

(72) Inventors: Mika NISHIWAKI, Tokyo (JP); Jun IMAGI, Tokyo (JP)

(21) Appl. No.: 16/324,711

(22) PCT Filed: Aug. 10, 2017
(86) PCT No.: PCT/JP2017/029025

§ 371 Date: Feb. 11, 2019

(30) Foreign Application Priority Data
Aug. 22, 2016 (JP) 2016-161728

(51) Int. Cl. A23D 9/007; A23D 9/04; A23L 5/10; A23L 27/20

(52) U.S. Cl. CPC A23D 9/007; A23D 9/04; A23V 2002/00; A23L 27/206; A23L 5/11

(57) ABSTRACT

Provided is an oil or fat composition for fried foods which is capable of achieving a satisfactory improvement in the flavour of fried foods. Also provided are: a method for producing the oil or fat composition for fried foods; a method for producing fried foods which uses the oil or fat composition for fried foods; and a method for imparting cheese flavour to fried foods. The oil or fat composition for fried foods includes an oxidized oil or fat which has a peroxide value of 15 to 280, and which includes at least 10 mass % but not more than 100 mass % of milk fat. Furthermore, the method for producing the oil or fat composition for fried foods includes a step in which an oxidized oil or fat, which has a peroxide value of 15 to 280, and which includes at least 10 mass % but not more than 100 mass % of milk fat, is added to an edible oil or fat. Moreover, the method for producing fried foods includes a step in which a fried food raw ingredient is fried in the oil or fat composition for fried foods. Furthermore, the method for imparting cheese flavour to fried foods uses the oil or fat composition for fried foods.

### TECHNICAL FIELD

The present invention relates to an oil or fat composition for fried foods, the oil or fat composition being suited to improving the flavor of fried foods, a method for producing an oil or fat composition for fried foods, a method for producing fried foods in which the oil or fat composition for fried foods is used; and a method for imparting a cheese flavor to fried foods.

### BACKGROUND ART

In the past, soybean oil, canola oil, corn oil, and other such edible oils or fats have been used in fried foods such as tempura and various deep-fried foods, and a variety of techniques for the purpose of preventing deterioration during cooking with heat are known. For example, patent document 1 (Japanese Laid-Open Patent Application No. 2004-173614) discloses an oil or fat composition for fried foods in which it is possible to inhibit the deterioration of the oil or fat during cooking, particularly to inhibit discoloration and cooked odors, and to sustain this effect for a long period of time in a high-temperature range, without affecting the mouthfeel, flavor, and external appearance of various deep-fried foods, karaage, etc.

There are known flavor oils in which an edible oil or fat is treated by an essence or an ingredient, whereby a flavor derived from the essence or ingredient is imparted. For various ingredients, such as: green onion, garlic, chili pepper, basil, and other such vegetables; shrimp, dried sardines, dried bonito, and other such marine products; soy sauce and other such seasonings; etc., it is easy to perform cooking, processing, and other such procedures on food products in which a characteristic flavor derived from the ingredient is enhanced. Therefore, these flavor oils are popular in industrial settings, as shall be apparent, and also with household consumers. However, flavor oils typically present a disadvantage in that the flavor readily disappears due to heating, etc. In relation to such problems, patent document 2 (Japanese Laid-Open Patent Application No. 2014-113116), for example, discloses a method for maintaining flavor during heating by adding a prescribed emulsifier to a flavor oil.

In relation to the imparting of an essence or flavor to a food product, attempts for imparting a butter flavor using milk fat have been carried out. For example, patent document 3 (Japanese Laid-Open Patent Application No. 64-39962) discloses a method for producing a food product to which a buttery essence has been imparted, the method involving adding butter fat that contains a prescribed amount of a prescribed compound. In addition, patent document 4 (Japanese Laid-Open Patent Application No. 09-94062) discloses a method for producing a butter essence in which, after milk fat has been hydrolyzed by enzymes, the milk fat is irradiated with ultraviolet rays and oxidized such that the peroxide value (POV) is within the range of 1.5 to 9.0.

### RELATED ART DOCUMENTS

### Patent Documents

[Patent Document 1] Japanese Laid-Open Patent Application No. 2004-173614

[Patent Document 2] Japanese Laid-Open Patent Application No. 2014-113116

[Patent Document 3] Japanese Laid-Open Patent Application No. 64-39962

[Patent Document 4] Japanese Laid-Open Patent Application No. 09-94062

### DISCLOSURE OF THE INVENTION

### Problems to be Solved by the Invention

However, in the feature disclosed in patent document 1, although the quality of the oil or fat composition is improved, no effect for improving the flavor of fried foods was achieved. In addition, in cases of cooking with heat at high temperatures, as with fried foods, the features disclosed in patent documents 2 to 4 achieve only a limited effect for maintaining or imparting flavor.

Accordingly, it is an object of the present invention to provide an oil or fat composition for fried foods with which it is possible to achieve a satisfactory effect for improving the flavor of fried foods. Additional objects of the present invention include providing a method for producing an oil or fat composition for fried foods, providing a method for producing fried foods in which the oil or fat composition for fried foods is used, and providing a method for imparting a cheese flavor to fried foods.

### Means to Solve the Problems

As a result of thoroughgoing investigations for the purpose of attaining the objects described above, the inventors discovered that using an oxidized oil or fat that includes milk fat in an oil or fat composition for fried foods yields an effect for improving the flavor of fried foods in which the oil or fat composition for fried foods is used, and thereby perfected the present invention.

Specifically, according to a first aspect of the present invention, there is provided an oil or fat composition for fried foods, the oil or fat composition being characterized by comprising an oxidized oil or fat that has a peroxide value of 15 to 280 and contains 10 to 100% by mass of milk fat.

The oxidized oil or fat content in the oil or fat composition for fried foods of the present invention preferably is 0.01 to 10% by mass.

The peroxide value of the oxidized oil or fat in the oil or fat composition for fried foods of the present invention preferably is 40 to 250.

According to a second aspect of the present invention, there is provided a method for producing an oil or fat composition for fried foods, the method being characterized by comprising a step for adding, to an edible oil or fat, an oxidized oil or fat that has a peroxide value of 15 to 280 and contains 10 to 100% by mass of milk fat.

The oxidized oil or fat in the method for producing an oil or fat composition for fried foods of the present invention preferably is obtained by performing heating while supplying oxygen to a raw-ingredient oil or fat that contains milk fat.

The raw-ingredient oil or fat in the method for producing an oil or fat composition for fried foods of the present invention preferably contains 60 to 100% by mass of milk fat.

The heating in the method for producing an oil or fat composition for fried foods of the present invention preferably is carried out at 65 to 150° C. for 1 to 72 hours.

The supply of oxygen in the method for producing an oil or fat composition for fried foods of the present invention preferably is performed at a rate of 0.001 to 2 L/min per kilogram of the raw-ingredient oil or fat.

The milk fat in the method for producing an oil or fat composition for fried foods of the present invention preferably is anhydrous milk fat.

The oil or fat composition for fried foods in the method for producing an oil or fat composition for fried foods of the present invention preferably contains 0.01 to 10% by mass of the oxidized oil or fat.

According to a third aspect of the present invention, there is provided a method for producing fried foods, the method being characterized by comprising a step for frying a fried-food raw ingredient using the oil or fat composition for fried foods described above.

According to a fourth aspect of the present invention, there is provided a method for imparting a cheese flavor to fried foods, the method being characterized in that the oil or fat composition for fried foods described above is used.

### Advantageous Effects of the Invention

According to the present invention, through use of an oxidized oil or fat that contains milk fat and has specified properties, there is achieved an effect for improving the flavor of fried foods that are fried in an oil or fat composition made to contain the oxidized oil or fat.

### BEST MODE FOR CARRYING OUT THE INVENTION

The oil or fat composition for fried foods according to the present invention contains an oxidized oil or fat that contains milk fat. “Milk fat” refers to a substance that is obtained from raw milk, cow milk, certified milk, etc., and has an oil or fat content of 95 to 100% by mass. Examples include anhydrous milk fat and clarified butter. Anhydrous milk fat refers to a substance in which substantially all components other than milk fat have been removed from cow milk, etc., and may also be expressed as AMF, butter oil, etc. Clarified butter is a substance in which the oil or fat component of butter has been fractionated. The milk fat in the present invention preferably is anhydrous milk fat or clarified butter, and more preferably is anhydrous milk fat. In addition, the oil or fat content of the milk fat preferably is 98 to 100% by mass, and more preferably is 99 to 100% by mass.

The oxidized oil or fat used in the present invention has a milk fat content of 10 to 100% by mass. This milk fat content preferably is 15 to 100% by mass, more preferably is 20 to 100% by mass, even more preferably is 40 to 100% by mass, still more preferably is 50 to 100% by mass, particularly preferably is 65 to 100% by mass, more particularly preferably is 95 to 100% by mass, and most preferably is 100% by mass (i.e., milk fat alone).

The oxidized oil or fat may include an edible oil or fat other than milk fat. There is no particular limitation as to the edible oil or fat other than milk fat. One or more from among medium-chain fatty acid triglycerides, soybean oil, canola oil, corn oil, palm oil, and fractionated palm oil is preferred; one or more from among medium-chain fatty acid triglycerides, soybean oil, and canola oil is more preferred; and canola oil is even more preferred. The oxidized oil or fat may contain an auxiliary agent, etc., that can be added to normal oils or fats, provided that the auxiliary agent does not inhibit the effect of the present invention.

The oxidized oil or fat used in the present invention has a peroxide value (also referred to as “POV” below) of 15 to 280. The peroxide value (POV) preferably is 25 to 265, more preferably is 30 to 265, even more preferably is 40 to 250, still more preferably is 52 to 250, and particularly preferably is 70 to 250. The peroxide value (POV) can be measured in conformance with, e.g., the method listed in the Japan Oil Chemists' Society's “Standard methods for the analysis of fats, oils and related materials: 2.5.2 Peroxide value,” etc.

The oxidized oil or fat used in the present invention can be prepared by, e.g., oxidizing a prescribed raw-ingredient oil or fat as described below. However, the description given below is in no way intended to limit the scope of the present invention particularly to oxidized oils or fats obtained using this method. Specifically, any oxidized oil or fat satisfying the properties described above may be suitably used in the present invention.

The raw-ingredient oil or fat for preparing the oxidized oil or fat has a milk fat content of 10 to 100% by mass. This milk fat content preferably is 15 to 100% by mass, more preferably is 20 to 100% by mass, even more preferably is 40 to 100% by mass, still more preferably is 50 to 100% by mass, particularly preferably is 65 to 100% by mass, more particularly preferably is 95 to 100% by mass, and most preferably is 100% by mass (i.e., milk fat alone).

In addition, the raw-ingredient oil or fat may include an edible oil or fat other than milk fat. There is no particular limitation as to the edible oil or fat other than milk fat. One or more from among medium-chain fatty acid triglycerides, soybean oil, canola oil, corn oil, palm oil, and fractionated palm oil is preferred; one or more from among medium-chain fatty acid triglycerides, soybean oil, and canola oil is more preferred; and canola oil is even more preferred. The water content of the raw-ingredient oil or fat is, e.g., less than 1% by mass.

There is no particular limitation as to the method for oxidation; it is preferable to supply oxygen to the raw-ingredient oil or fat to perform oxidation. It does not matter if the oxygen supply source is oxygen alone; the supply source may include oxygen from air, etc., and preferably is air. The oxygen supply quantity preferably is 0.00 to 2 L/min per kilogram of the raw-ingredient oil or fat, more preferably is 0.005 to 2 L/min, and even more preferably is 0.02 to 2 L/min. In the case of air, for example, the supply quantity preferably is 0.005 to 10 L/min per kilogram of the raw-ingredient oil or fat, more preferably is 0.025 to 10 L/min, even more preferably is 0.1 to 10 L/min, and still more preferably is 0.3 to 5 L/min. It is preferable to stir the raw-ingredient oil or fat when performing oxidation. The temperature for performing oxidation preferably is 65 to 150° C., more preferably is 70 to 140° C., even more preferably is 75 to 140° C., and still more preferably is 90 to 140° C. There is no particular limitation as to the length of time for performing oxidation; 1 to 72 hours is preferred, 3 to 72 hours is more preferred, and 5 to 72 hours is even more preferred.

The oil or fat composition for fried foods according to the present invention can be prepared by adding the oxidized oil or fat described above to, e.g., a prescribed edible oil or fat. However, the description given below is in no way intended to limit the scope of the present invention particularly to an oil or fat composition for fried foods that is obtained using this method. Specifically, any oil or fat composition for fried foods that contains an oxidized oil or fat satisfying the properties described above is encompassed in the scope of the present invention.

An edible substance can be appropriately used as the edible oil or fat for preparing the oil or fat composition for fried foods. Examples of this edible substance include: soybean oil, canola oil, palm oil, corn oil, olive oil, sesame oil, safflower oil, sunflower oil, cottonseed oil, rice-bran oil, peanut oil, palm kernel oil, coconut oil, cacao oil, and other such vegetable oils; cow fat, pig fat, chicken fat, and other such animal fats; medium-chain fatty acid triglycerides; and processed fats and oils obtained by performing fractionation, hydrogenation, ester exchange, etc., on these fats and oils. One type of edible oil or fat may be used alone, or two or more types of edible oils or fats may be used in combination. Among these edible oils or fats, from the standpoint of workability, etc., during production, an edible oil or fat obtained by compounding at least 60% by mass of one or more selected from among soybean oil, canola oil, corn oil, palm olein, and other such oils or fats having an iodine value of 50 or higher is preferred, and an edible oil or fat obtained by compounding at least 80% by mass of the same is more preferred.

The oxidized oil or fat content in the oil or fat composition for fried foods preferably is 0.01 to 10% by mass, more preferably is 0.01 to 8% by mass, even more preferably is 0.03 to 8% by mass, and most preferably is 0.05 to 5% by mass. In the oxidized oil or fat content in the oil or fat composition for fried foods, the milk fat contained in the oxidized oil or fat preferably constitutes 0.001 to 10% by mass, more preferably constitutes 0.001 to 8% by mass, even more preferably constitutes 0.003 to 8% by mass, and most preferably constitutes 0.005 to 5% by mass. Accordingly, the oil or fat composition for fried foods of the present invention preferably is prepared by adding the oxidized oil or fat to the edible oil or fat so as to reach the content amounts described above. In addition, an anti-oxidant, an emulsifier, a fragrance, or other such additional ingredients may be furthermore compounded, provided that the additional ingredients do not inhibit the operational effect of the present invention. Specific examples include ascorbic fatty acid esters, lignans, coenzyme Q, γ-oryzanol, and tocopherol.

The oil or fat composition for fried foods according to the present invention can be suitably used in French fries, tempura, croquettes, karaage, deep-fried pork cutlet, fried fish, corn dogs, chicken nuggets, deep-fried tofu, doughnuts, deep-fried bread, fried rice crackers, snack foods, instant ramen, and other such fried foods. There is no particular limitation as to the method for producing the fried foods; appropriate and desired fried foods may be produced, using the oil or fat composition for fried foods according to the present invention, through methods suited to the fried foods in accordance with the types of each of the fried foods. Specifically, the prescribed fried-food raw ingredients may be prepared by frying in a state in which the temperature of the oil or fat composition for fried foods according to the present invention is typically 150 to 210° C., and more typically 160 to 200° C.

The fried foods in which the oil or fat composition for fried foods according to the present invention is used have excellent flavor and savor, as indicated in the examples described below. In particular, the effect for imparting a cheese flavor is exceptional.

A discretionary combination of the configurations described in the present specification, a composition or method that includes said configurations, etc., can also be effective as an embodiment of the present invention. For example, according to the present invention, there are provided “a use for an oxidized oil or fat that has a peroxide value of 15 to 280 and contains 10 to 100% by mass of milk fat, the use being for the purpose of imparting a flavor to fried foods”, “a use for an oxidized oil or fat that has a peroxide value of 15 to 280 and contains 10 to 100% by mass of milk fat, the use being for the purpose of producing a composition for imparting a flavor to fried foods”, etc.

### EXAMPLES

The present invention is more specifically described below through the use of examples, but the present invention is in no way limited by these examples.

(Preparation of Oxidized Oil or Fat: Part 1)

500 g of anhydrous milk fat (trade name: Butter Oil CML, manufactured by Maruwayushi Co., Ltd., oil or fat content: 99.8% by mass, water content: less than 1% by mass) was introduced into a stainless steel beaker, and the milk fat was stirred and air (500 mL/min) was supplied thereto while the milk fat was kept at a temperature of 100° C. A sample was taken after the heat-retention time indicated in table 1, and an oxidized oil or fat was obtained (preparation examples 1 to 15).

The peroxide value (POV) of the resulting oxidized oil or fat was measured in conformance with the Japan Oil Chemists' Society's “Standard methods for the analysis of fats, oils and related materials: 2.5.2 Peroxide value.” The results are shown in table 1, together with the heat-retention temperature and the heat-retention time used during preparation.

TABLE 1
1-1

| | Preparation | Preparation | Preparation | Preparation | Preparation | Preparation | Preparation | Preparation |
|---|---|---|---|---|---|---|---|---|
| | example 1 | example 2 | example 3 | example 4 | example 5 | example 6 | example 7 | example 8 |
| Heat- | — | 100 | 100 | 100 | 100 | 100 | 100 | 100 |
| retention | | | | | | | | |
| temperature | | | | | | | | |
| (° C.) | | | | | | | | |
| Heat- | 0 | 18 | 19 | 20 | 20.5 | 21 | 22.5 | 23.5 |
| retention | | | | | | | | |
| time | | | | | | | | |
| (hours) | | | | | | | | |
| Peroxide | 0.9 | 15.0 | 30.0 | 45.0 | 60.0 | 80.0 | 110.0 | 140.0 |
| value | | | | | | | | |

1-2

| | | Preparation | Preparation | Preparation | Preparation | Preparation | Preparation |
|---|---|---|---|---|---|---|---|
| | Preparation example 9 | example 10 | example 11 | example 12 | example 13 | example 14 | example 15 |
| Heat-retention | 100 | 100 | 100 | 100 | 100 | 100 | 100 |
| temperature (° C.) | | | | | | | |
| Heat-retention | 24 | 24.5 | 25 | 25.5 | 25.75 | 26 | 26.25 |
| time (hours) | | | | | | | |
| Peroxide value | 160.0 | 180.0 | 200.0 | 220.0 | 240.0 | 250.0 | 265.0 |

### [Test Example 1] (Use of High Amount of Oxidized Oil or Fat)

A palm-based oil (“Palm Olein (iodine value: 67),” manufactured by J-Oil Mills, Inc.) was used as an edible oil or fat serving as a base, 1 part by mass of the oxidized oil or fat in any of preparation examples 1 to 9 was added to 99 parts by mass of the edible oil or fat, and an oil or fat composition for fried foods was obtained (examples 1 to 9). The oil or fat composition for fried foods was used, at an oil temperature of 180° C., to prepare each of French fries that are a commercially available frozen food, eggplant tempura in which commercially available tempura flour was used, and beef croquettes that are a commercially available frozen food. Evaluations of each of the intensity of the butter and cheese flavor of the French fries, the effect for enhancing the sweetness of the eggplant in the tempura, and the effect for enhancing the saltiness of the croquettes were aggregated, the evaluations being carried out by expert panelists (n=3) using the evaluation standard indicated below.

(Evaluation Standard)

⊚: Strongly evident

◯: Evident

Δ: Minimally evident

x: Not evident

The results are shown in table 2.

TABLE 2

| | | | | | | | Effect for | |
|---|---|---|---|---|---|---|---|---|
| | | | Added | | Intensity | Intensity | enhancing | Effect for |
| | Oxidized | Peroxide | amount | Type of oil | of butter | of cheese | sweetness | enhancing |
| | oil or fat | value | (mass %) | or fat used | flavor | flavor | of eggplant | saltiness |
| Control | None added | — | — | IV67¹* | X | X | X | X |
| Example 1 | Preparation | 0.9 | 1.0 | IV67¹* | ◯ | X | X | X |
| | example 1 | | | | | | | |
| Example 2 | Preparation | 15.0 | 1.0 | IV67¹* | Δ | Δ | Δ | Δ |
| | example 2 | | | | | | | |
| Example 3 | Preparation | 30.0 | 1.0 | IV67¹* | Δ | ◯ | ◯ | ◯ |
| | example 3 | | | | | | | |
| Example 4 | Preparation | 45.0 | 1.0 | IV67¹* | Δ | ⊚ | ⊚ | ⊚ |
| | example 4 | | | | | | | |
| Example 5 | Preparation | 60.0 | 1.0 | IV67¹* | X | ⊚ | ⊚ | ⊚ |
| | example 5 | | | | | | | |
| Example 6 | Preparation | 80.0 | 1.0 | IV67¹* | X | ⊚ | ⊚ | ⊚ |
| | example 6 | | | | | | | |
| Example 7 | Preparation | 110.0 | 1.0 | IV67¹* | X | ⊚ | ⊚ | ⊚ |
| | example 7 | | | | | | | |
| Example 8 | Preparation | 140.0 | 1.0 | IV67¹* | X | ⊚ | ⊚ | ⊚ |
| | example 8 | | | | | | | |
| Example 9 | Preparation | 160.0 | 1.0 | IV67¹* | X | ⊚ | ⊚ | ⊚ |
| | example 9 | | | | | | | |

IV67¹*Palm olein (iodine value: 67)

According to the results, a butter flavor was imparted to French fries in preparation example 1, in which the peroxide value (POV) of the oxidized oil or fat was 0.9. The butter flavor was minimal in preparation example 2, in which the peroxide value (POV) of the oxidized oil or fat was 15.0, in preparation example 3, in which the peroxide value (POV) was 30.0, and in preparation example 4, in which the peroxide value (POV) was 45.0. The butter flavor was not evident in preparation examples 5 to 9, in which the peroxide value (POV) of the oxidized oil or fat was 60 or higher. Specifically, as the peroxide value (POV) of the oxidized oil or fat increased, the effect for imparting a butter flavor through use of the oxidized oil or fat disappeared, but the intensity of a cheese flavor in French fries increased, the sweetness of eggplant in tempura intensified, and the saltiness of croquettes intensified.

### [Test Example 2] (Use of Low Amount of Oxidized Oil or Fat)

Palm olein (iodine value: 67) was used as an edible oil or fat serving as a base, 0.1 part by mass of the oxidized oil or fat in any of preparation examples 5 to 9 was added to 99.9 parts by mass of the edible oil or fat, and an oil or fat composition for fried foods was obtained (examples 10 to 14). The oil or fat composition for fried foods was used, at an oil temperature of 180° C., to prepare French fries that are a commercially available frozen food. A flavor evaluation was performed in the same manner as in test example 1.

The results are shown in table 3.

TABLE 3

| | | | Added | Type of | Intensity | Intensity |
|---|---|---|---|---|---|---|
| | Oxidized | Peroxide | amount | oil or | of butter | of cheese |
| | oil or fat | value | (mass %) | fat used | flavor | flavor |
| Control | None added | — | — | IV67¹* | X | X |
| Example | Preparation | 60.0 | 0.1 | IV67¹* | X | Δ |
| 10 | example 5 | | | | | |
| Example | Preparation | 80.0 | 0.1 | IV67¹* | X | ◯ |
| 11 | example 6 | | | | | |
| Example | Preparation | 110.0 | 0.1 | IV67¹* | X | ⊚ |
| 12 | example 7 | | | | | |
| Example | Preparation | 140.0 | 0.1 | IV67¹* | X | ⊚ |
| 13 | example 8 | | | | | |
| Example | Preparation | 160.0 | 0.1 | IV67¹* | X | ⊚ |
| 14 | example 9 | | | | | |

IV67¹*Palm olein (iodine value: 67)

According to the results, the same trend was observed as in the results of test example 1. Specifically, in preparation examples 5 to 9, in which the peroxide value (POV) of the oxidized oil or fat was 60 or higher, no effect for imparting a butter flavor was observed, but a cheese flavor was more strongly evident in the French fries as the peroxide value (POV) of the oxidized oil or fat increased.

### [Test Example 3] (Use of High-POV Oxidized Oil or Fat)

Palm olein (iodine value: 67) was used as an edible oil or fat serving as a base, 0.1 part by mass of the oxidized oil or fat in any of preparation examples 9 to 15 was added to 99.9 parts by mass of the edible oil or fat, and an oil or fat composition for fried foods was obtained (examples 15 to 21). The oil or fat composition for fried foods was used, at an oil temperature of 180° C., to prepare each of French fries that are a commercially available frozen food and beef croquettes that are a commercially available frozen food. A flavor evaluation was performed in the same manner as in test example 1.

The results are shown in table 4.

TABLE 4

| | | | | | Intensity of | Intensity of | Effect for |
|---|---|---|---|---|---|---|---|
| | Oxidized oil | Peroxide | Added amount | Type of oil | butter | cheese | enhancing |
| | or fat | value | (mass %) | or fat added | flavor | flavor | saltiness |
| Control | None added | — | — | IV67¹* | X | X | X |
| Example 15 | Preparation | 160.0 | 0.1 | IV67¹* | X | ⊚ | ⊚ |
| | example 9 | | | | | | |
| Example 16 | Preparation | 180.0 | 0.1 | IV67¹* | X | ⊚ | ⊚ |
| | example 10 | | | | | | |
| Example 17 | Preparation | 200.0 | 0.1 | IV67¹* | X | ⊚ | ⊚ |
| | example 11 | | | | | | |
| Example 18 | Preparation | 220.0 | 0.1 | IV67¹* | X | ⊚ | ⊚ |
| | example 12 | | | | | | |
| Example 19 | Preparation | 240.0 | 0.1 | IV67¹* | X | ⊚ | ⊚ |
| | example 13 | | | | | | |
| Example 20 | Preparation | 250.0 | 0.1 | IV67¹* | X | ⊚ | ⊚ |
| | example 14 | | | | | | |
| Example 21 | Preparation | 260.0 | 0.1 | IV67¹* | X | ⊚ | ⊚ |
| | example 15 | | | | | | |

IV67¹*Palm olein (iodine value: 67)

According to the results, the same trend was observed as in the results of test examples 1 and 2. Specifically, in preparation examples 9 to 15, in which the peroxide value (POV) of the oxidized oil or fat was 160 or higher, no effect for imparting a butter flavor was observed, but a cheese flavor was strongly evident in the French fries, and the saltiness was strongly evident in the croquettes.

### [Test Example 4] (Use of Other Oils)

Any of palm olein (iodine value: 67), canola oil, and soybean oil (all manufactured by J-Oil Mills, Inc.) was used as an edible oil or fat serving as a base, 0.3 part by mass of the oxidized oil or fat in preparation example 7 was added to 99.7 parts by mass of each of these edible oils or fats, and an oil or fat composition for fried foods was obtained (examples 22, 23, and 24). The oil or fat composition for fried foods was used, at an oil temperature of 180° C., to prepare French fries that are a commercially available frozen food. A flavor evaluation was performed in the same manner as in test example 1.

The results are shown in table 5.

TABLE 5

| | | | Added | | Intensity |
|---|---|---|---|---|---|
| | Oxidized | Peroxide | amount | Type of oil | of cheese |
| | oil or fat | value | (mass %) | or fat used | flavor |
| Control | None added | — | — | IV67¹* | X |
| Exam- | Preparation | 110.0 | 0.3 | IV67¹* | ⊚ |
| ple 22 | example 7 | | | | |
| Control | None added | — | — | Canola oil | X |
| Exam- | Preparation | 110.0 | 0.3 | Canola oil | ⊚ |
| ple 23 | example 7 | | | | |
| Control | None added | — | — | Soybean oil | X |
| Exam- | Preparation | 110.0 | 0.3 | Soybean oil | ⊚ |
| ple 24 | example 7 | | | | |

IV67¹*: Palm olein (iodine value: 67)

According to the results, even in cases where canola oil or soybean oil was used as the base oil, the same trend was observed as in the results of test examples 1 to 3, in which a palm-based oil was used as the base oil. Specifically, due to the addition of the oxidized oil or fat in preparation example 7, in which the peroxide value (POV) was 110.0, a cheese flavor was imparted to the French fries.

(Preparation of Oxidized Oil or Fat: Part 2)

The following were prepared: (1) an oil or fat including 20% by mass of milk fat, the oil or fat being obtained by mixing 80 parts by mass of high-oleic-acid low-linoleic-acid canola oil (HOLL canola oil) (manufactured by J-Oil Mills, Inc., water content: less than 1% by mass) into 20 parts by mass of anhydrous milk fat; (2) an oil or fat including 50% by mass of milk fat, the oil or fat being obtained by mixing 50 parts by mass of the HOLL canola oil into 50 parts by mass of the anhydrous milk fat; and (3) anhydrous milk fat. 200 g of the prepared oil or fat or anhydrous milk fat was introduced into a stainless steel beaker, and the oil or fat was stirred and air (200 mL/min) was supplied thereto while the oil or fat was kept at a temperature of 100° C. A sample was taken after each of 30, 36, and 22 hours, respectively, and an oxidized oil or fat was obtained (preparation examples 16 to 18).

The peroxide value (POV) of the resulting oxidized oil or fat was measured in conformance with the Japan Oil Chemists' Society's “Standard methods for the analysis of fats, oils and related materials: 2.5.2 Peroxide value.” The results are shown in table 6, together with the compounding amounts of the anhydrous milk fat and the HOLL canola oil, the heat-retention temperature, and the heat-retention time.

TABLE 6

| | Preparation | Preparation | Preparation |
|---|---|---|---|
| | example 16 | example 17 | example 18 |
| Anhydrous milk | 20 | 50 | 100 |
| fat (parts by mass) | | | |
| HOLL canola oil²* | 80 | 50 | 0 |
| (parts by mass) | | | |
| Heat-retention | 100 | 100 | 100 |
| temperature (° C.) | | | |
| Heat-retention | 30 | 36 | 22 |
| time (hours) | | | |
| Peroxide value | 105.0 | 100.0 | 100.0 |

HOLL canola oil²*: High-oleic-acid low-linoleic-acid canola oil

HOLL canola oil²*: High-oleic-acid low-linoleic-acid canola oil

### [Test Example 5] (Use of Oxidized Oil or Fat Prepared Using Raw-Ingredient Oil or Fat Obtained by Mixing Milk Fat and Edible Oil or Fat Other than Milk Fat)

Canola oil was used as an edible oil or fat serving as a base, 1 part by mass of the oxidized oil or fat in any of preparation examples 16 to 18 was added to 99 parts by mass of the edible oil or fat, and an oil or fat composition for fried foods was obtained (examples 25 to 27). The oil or fat composition for fried foods was used, at an oil temperature of 180° C., to prepare French fries that are a commercially available frozen food. A flavor evaluation was performed in the same manner as in test example 1.

The results are shown in table 7.

TABLE 7

| | | | Amount | Type | Intensity |
|---|---|---|---|---|---|
| | Oxidized | Peroxide | added | of oil | of cheese |
| | oil or fat | value | (mass %) | or fat used | flavor |
| Control | None added | — | — | Canola oil | X |
| Example | Preparation | 105.0 | 1.0 | Canola oil | ◯ |
| 25 | example 16 | | | | |
| Example | Preparation | 100.0 | 1.0 | Canola oil | ⊚ |
| 26 | example 17 | | | | |
| Example | Preparation | 100.0 | 1.0 | Canola oil | ⊚ |
| 27 | example 18 | | | | |

According to the results, even in cases where there was used an oxidized oil or fat prepared using a raw-ingredient oil or fat obtained by mixing milk fat and an edible oil or fat other than milk fat, the same trend was observed as in the results of test examples 1 to 4. Specifically, a cheese flavor was imparted to French fries by adding the oxidized oil or fat in preparation example 16, which had a peroxide value (POV) of 105.0 and was obtained from a raw-ingredient oil or fat including 20% by mass of milk fat. In addition, a cheese flavor was strongly evident in the case of adding the oxidized oil or fat in preparation example 17, which had a peroxide value (POV) of 100.0 and was obtained from a raw-ingredient oil or fat including 50% by mass of milk fat, and the same is true for the addition of the oxidized oil or fat in preparation example 18, which had a peroxide value (POV) of 100.0 and was obtained from a raw-ingredient oil or fat consisting of anhydrous milk fat.

(Preparation of Oxidized Oil or Fat: Part 3)

Two types of oils or fats were prepared, the oils or fats including 70% by mass of milk fat in which 60 g of a medium-chain fatty acid triglyceride (trade name: MCT Actor M-107FR, manufactured by Riken Vitamin Co., Ltd., water content: less than 1% by mass) or soybean oil (water content: less than 1% by mass), respectively, was mixed into 140 g of anhydrous milk fat. 200 g of the prepared oils or fats was introduced into respective stainless steel beakers, and the oils or fats were stirred and air (200 mL/min) was supplied thereto while the oils or fats were kept at a temperature of 120° C. A reaction was carried out for 13 hours, and oxidized oils or fats were obtained (preparation examples 19 and 20).

The peroxide values (POV) of the resulting oxidized oils or fats were measured in conformance with the Japan Oil Chemists' Society's “Standard methods for the analysis of fats, oils and related materials: 2.5.2 Peroxide value.” According to the results, the peroxide value (POV) in preparation example 19 was 58.7, and the peroxide value (POV) in preparation example 20 was 44.6.

### <Production Example 1> (Production of Oil or Fat Composition for Fried Foods to which is Added Oxidized Oil or Fat Prepared Using Raw-Ingredient Oil or Fat Obtained by Mixing Milk Fat and Edible Oil or Fat Other than Milk Fat)

1 part by mass of the oxidized oil or fat in either preparation example 19 or preparation example 20 was added to 99 parts by mass of soybean oil, and an oil or fat composition for fried foods was obtained (examples 28 and 29).

1. An oil or fat composition for fried foods, the fat composition being characterized by comprising an oxidized oil or fat that has a peroxide value of 15 to 280 and contains 10 to 100% by mass of milk fat.

2. The oil or fat composition for fried foods of claim 1, wherein the oxidized oil or fat content is 0.01 to 10% by mass.

3. The oil or fat composition for fried foods of claim 1, wherein the peroxide value of the oxidized oil or fat is 40 to 250.

4. A method for producing an oil or fat composition for fried foods, the method being characterized by comprising a step for adding, to an edible oil or fat, an oxidized oil or fat that has a peroxide value of 15 to 280 and contains 10 to 100% by mass of milk fat.

5. The production method of claim 4, wherein the oxidized oil or fat is obtained by performing heating while supplying oxygen to a raw-ingredient oil or fat that contains milk fat.

6. The production method of claim 5, wherein the raw-ingredient oil or fat contains 60 to 100% by mass of milk fat.

7. The production method of claim 5, wherein the heating is carried out at 65 to 150° C. for 1 to 72 hours.

8. The production method of claim 5, wherein the supply of oxygen is performed at a rate of 0.001 to 2 L/min per kilogram of the raw-ingredient oil or fat.

9. The production method of claim 5, wherein the milk fat is anhydrous milk fat.

10. The production method of claim 4, wherein the oil or fat composition for fried foods contains 0.01 to 10% by mass of the oxidized oil or fat.

11. A method for producing fried foods, the method being characterized by comprising a step for frying a fried-food raw ingredient using the oil or fat composition for fried foods of claim 1.

12. A method for imparting a cheese flavor to fried foods, the method being characterized in that the oil or fat composition for fried foods of claim 1.
